(19) United States
(12) Patent Application Publication
(10) Pub. No.: US 2003/0001066 A1
(43) Pub. Date: Jan. 2, 2003

(54) Mechanism for the relative positioning of telescopic members

(76) Inventors: Er-Jui Chen, Kaohsiung Hsien (TW); Ling-Chuan Chang, Chia-I City (TW); Cheng-Fan Yang, Tainan Hsien (TW)

Correspondence Address: BIRCH STEWART KOLASCH & BIRCH, PO BOX 747, FALLS CHURCH, VA, 22040-0747, US

(21) Appl. No.: 09/893,882

(22) Filed: Jun. 29, 2001

(51) Int. Cl. F16M 13/00

(52) U.S. Cl. 248/511; 248/539

(57) ABSTRACT

A positioning mechanism is comprised of a first member having a plurality of notches, a second member having a hole that can slide within the first member, and an engagement member provided in the second member having a latched member and a flexible member, wherein the latched member is passed through the hole of the second member to engage with one of the notches of the first member in a locked position. When the engagement member is activated to compress the flexible member, which in turn moves the latched member inward, the latched member moves from the notch of the first member and the hole of the second member, thus unlocking the second member. By utilizing this, a relative positioning of telescopic members is achieved.

### BACKGROUND OF THE INVENTION

1. Field of Invention

The invention relates to slidable members and more particularly to a mechanism for the relative positioning of telescopic members mounted on highchairs, strollers, and the like.

2. Related Art

Length adjustment mechanisms for slidable members are well known. Such mechanisms are provided to fit different individuals with various heights, weights and job tasks. A plurality of applications can be found as detailed below:

1. Retractable handle for luggage. It is advantageous if a user can pull the handle out to an appropriate length when in use, while retracting the handle to rest on the bezel when not is use for saving storage space.

2. Retractable clothes hanger. This is adapted to the length of a specific place such as a balcony.

3. Highchair with adjustable seat height. This is advantageous when used in restaurants to fit toddlers. Alternatively, it can be retracted to a minimum storage space when not in use.

4. Stroller with adjustable length with respect to its handle or frame. It is advantageous to fit different individuals pushing the stroller. Furthermore, it is convenient to fold such strollers when not in use.

Conventionally, length adjustment mechanisms are implemented in sliding members and support members wherein the sliding members are secured to the support members. Typically, there are two forms of adjustment. They are a single segment adjustment in which the sliding member is only allowed to secure to one of two positions with respect to the support member, and a multi-segment adjustment, wherein the sliding member is allowed to secure to any one of at least three positions with respect to the support member.

The engagement between the sliding member and the support member is usually made possible by providing a plurality of holes and a cooperating depressible spring. The holes are made separately from the depressible spring. In a locked position, the sliding member and the support member are secured together when the spring moves into one of the holes. Alternatively, in an unlocked position the sliding member becomes disengaged from the support member when the spring clears the hole.

It is not easy to mount the spring in the narrow tube of the sliding member. Furthermore, a precise alignment between one hole and the spring is not easy. As such, the conventional hole and spring arrangment is expensive to implement and is time consuming, due to the complicated assembly of many components.

### SUMMARY OF THE INVENTION

It is therefore an object of the invention to provide a mechanism for the relative positioning of telescopic members, wherein the adjustment is done by a single element having the necessary elasticity and an engagement device for carrying out the vertical adjustment of the telescopic member.

The advantages of the invention are realized by providing a mechanism for the relative positioning of telescopic members comprising a first member having a plurality of notches vertically disposed along its length, a second member with a hole that can slide within the first member, and an engagement member provided in the second member having a latched member and a flexible member, wherein the latched member passes through the hole of the second member to engage with one of the notches of the first member in a locked position. When the engagement member is activated to compress the flexible member, which in turn moves the latched member inward, the latched member of the engagement member moves from the notch of the first member and the hole of the second member, thus unlocking the second member. By utilizing this, a relative positioning of the telescopic member is achieved.

Further scope of applicability of the invention will become apparent from the detailed description given hereinafter. However, it should be understood that the detailed description and specific examples, while indicating preferred embodiments of the invention, are given by way of illustration only, since various charges and modifications within the spirit and scope of the invention will become apparent to those skilled in the art from this detailed description.

### BRIEF DESCRIPTION OF THE DRAWINGS

The invention will become fully understood from the detailed description given hereinbelow. However, this description is for purposes of illustration only, and thus is not limitative of the present invention, wherein:

FIG. 1 is an exploded view of a first preferred embodiment of the mechanism for the relative positioning of telescopic members according to the invention;

FIG. 2 is a perspective view of the engagement member of FIG. 1;

FIG. 3A is a cross-sectional view showing the mechanism in a locked position;

FIG. 3B is similar to FIG. 3A where the mechanism is being unlocked;

FIG. 4 is a perspective view of a swing equipped with the mechanism of the invention; and

FIG. 5 is a cross-sectional view showing a second preferred embodiment of the mechanism for the relative positioning of telescopic members according to the invention.

### DETAILED DESCRIPTION OF THE INVENTION

The mechanism for the relative positioning of telescopic members of the invention may be implemented in any telescopic members such as strollers, swings, highchairs, and the like.

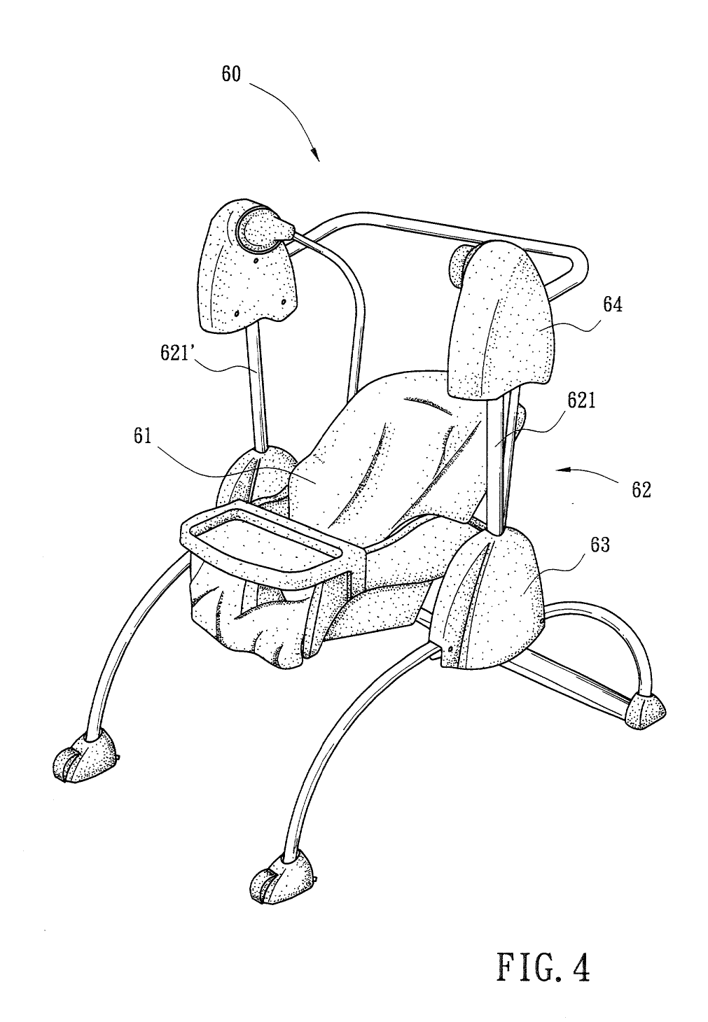

FIG. 4 shows a swing equipped with the mechanism for the relative positioning of telescopic members in accordance with the invention. The swing is comprised of a seat 61 and a frame 62 having two posts 621 and 621′, two latches 63 on the bottom ends of posts 621 and 621′, and two brackets 64 on the top ends of posts 621 and 621′ with seat 61 attached therebetween. Thus, it is possible to adjust the height of seat 61 by utilizing the mechanism of the invention.

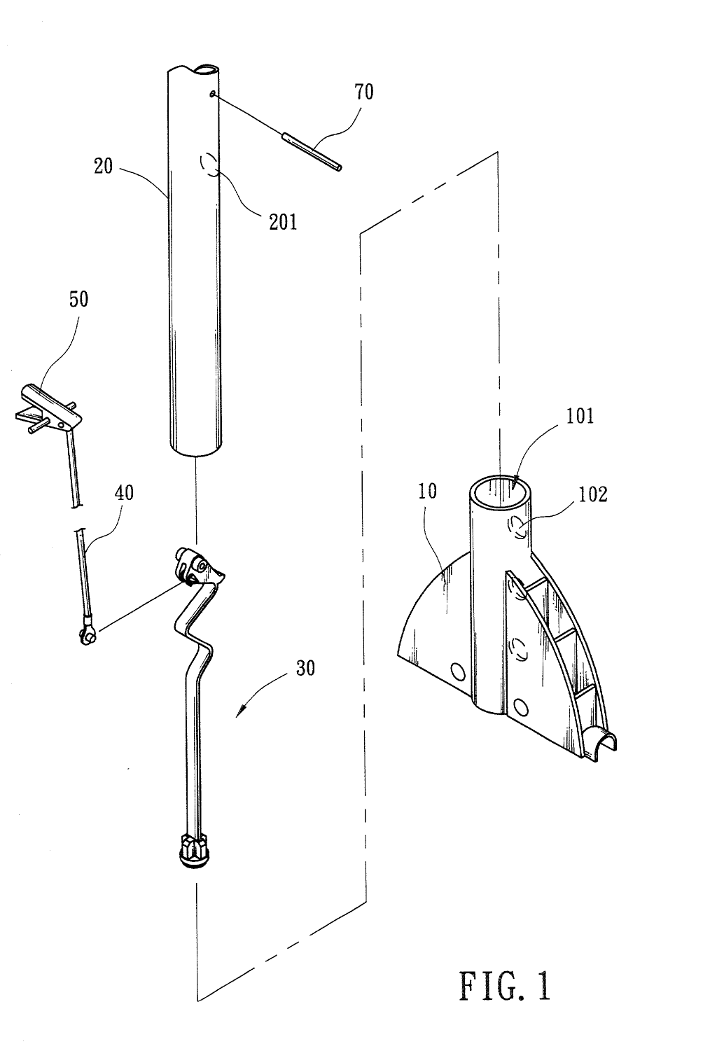

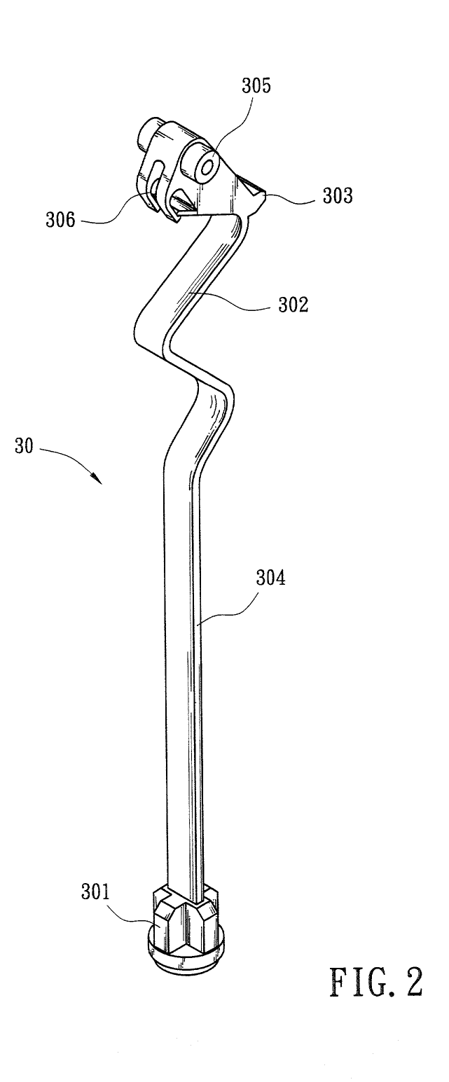

FIGS. 1 and 2 illustrate the mechanism of the invention comprising a first member 10, a second member 20, an engagement member 30, a connecting cable 40, and a trigger member 50. Each of these elements is detailed below.

The first member 10 is implemented as a base (in this embodiment) or a support tube. The first member 10 is comprised of a receiving space 101 and a plurality of notches 102 vertically disposed along its length.

The second member 20 is a tube that can slide within the receiving space 101 of first member 10 having a hole 201 in its wall.

Referring specifically to FIG. 2, the engagement member 30 is provided in the second member 20. The engagement member 30 is generally elongated to comprise a base 301 shaped to secure the engagement member 30 to the bottom of the second member 20. An elongated sheetlike extension member 304 extends upward from the base 301. A bent flexible member 302 is formed on top of the extension member 304. A latched member 303 is on top of the flexible member 302. The height of the latched member 303 (i.e., the total vertical length of the extension member 304 and the flexible member 302) must be enough to make it flush with the hole 201. A pivot member 305 is secured to the second member 20 by a pin 70, and an actuation member 306 is adjacent the pivot member 305.

The connecting cable 40 has a bottom end secured to the actuation member 306 and a top end secured to the trigger member 50, which is provided on the outside of the second member 20 for ease of operation.

The following is a description of the operation of the mechanism:

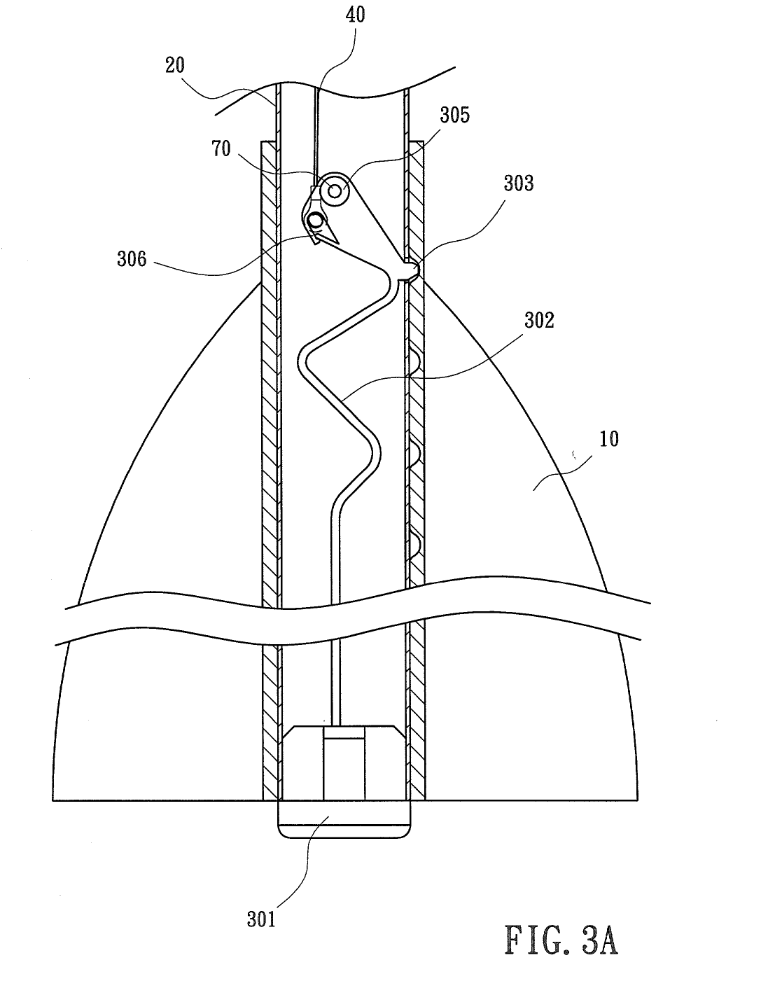

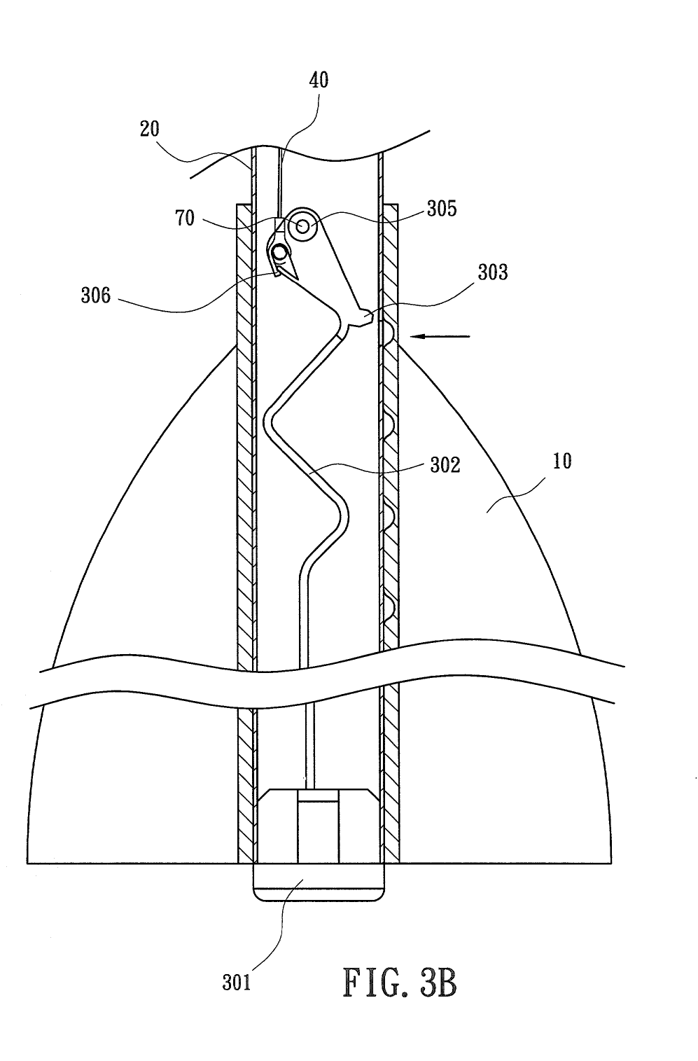

Referring to FIG. 3A, the latched member 303 of the engagement member 30 is passed through the hole 201 of the second member 20 to engage with one of the notches 102 of the first member 10 in a normal locked position. This is a desired position selected by the user.

Referring to FIG. 3B, the user presses the trigger member 50 to cause the connecting cable 40 to move up, which in turn causes the actuation member 306 to pivot counterclockwise around the pivot member 305. As such, the flexible member 302 is compressed to move inward, which in turn causes the latched member 303 of the engagement member 30 to move from the notch 102 of the first member 10 and the hole 201 of the second member 20, thus unlocking the second member 20. As a result, the second member 20 may slide into the receiving space 101 of the first member 10 until moved to a desired position. At this position, the latched member 303 of the engagement member 30 is again passed through the hole 201 of the second member 20 to engage with one of the notches 102 of the first member 10 by the restored elastic force of the flexible member 302, as shown in FIG. 3A.

Note that the mechanism may be implemented in each bracket 64 of the swing of FIG. 4. As a result, it is possible to adjust the height of seat 61 by utilizing this mechanism.

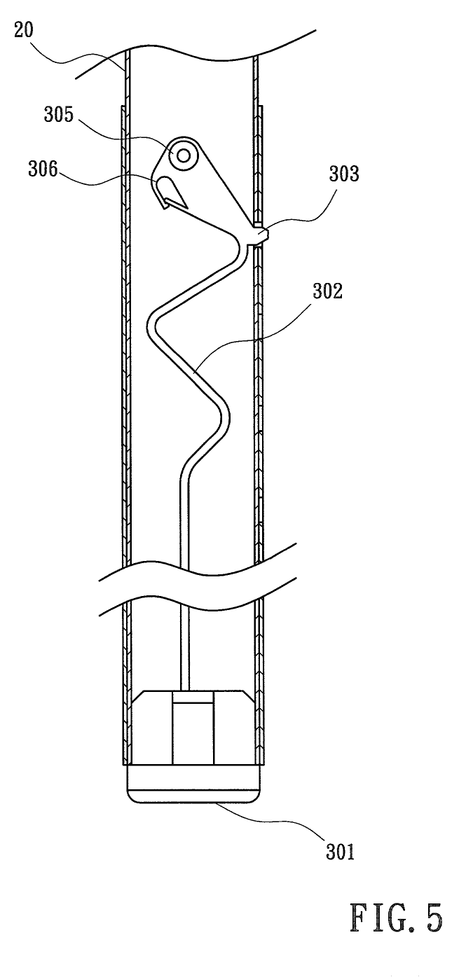

FIG. 5 shows a second preferred embodiment of the mechanism according to the invention. The differences between the first and second preferred embodiments are described as follows. The connecting cable 40 and trigger member 50 are eliminated. Also, the first member 10 is implemented as a support tube. Furthermore, the notches 102 of the first embodiment are replaced by apertures 102 in the second embodiment. The latched member 303 is projected above the aperture 102 in a normal locked position. To adjust the relative position of the second member 20 with respect to the first member 10, simply push the latched member 303 to cause it to move from the aperture 102 of the first member 10 and the hole 201 of the second member 20.

The benefits of this invention, including the locking and unlocking of the first and second members 10 and 20, are carried out by utilizing a single engagement member 30, resulting in a reduction in the manufacturing cost and a simplified assembly process.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A positioning mechanism comprising:
a first member having a plurality of notches vertically disposed along the length;
a second member slidable within the first member having a hole; and
an engagement member provided in the second member having a latched member and a flexible member;
wherein the latched member of the engagement member is passed through the hole of the second member to engage with one of the notches of the first member in a locked position, and when the engagement member is activated to compress the flexible member which in turn moves the latched member inward, the latched member of the engagement member clears from the notch of the first member and the hole of the second member, thus unlocking the second member.

2. The positioning mechanism of claim 1, wherein the first member is a base.

3. The positioning mechanism of claim 1, wherein the first member is a support bube.

4. The positioning mechanism of claim 1, wherein the second member is a sliding tube.

5. The positioning mechanism of claim 1, wherein the engagement member further comprises a base member shaped to secure the engagement member to the bottom of the second member, an extension member extended upward from the base member a flexible member formed on the top of the extension member, a pivot member pivotably secured to the second member by a through pin, and an actuation member adjacent the pivot member being counterclockwise pivotable about the pivot member when actuated for causing the flexible member to compress which in turn causes the latched member to move inward.

6. The positioning mechanism of claim 5, further comprising a trigger member on the outside of the second member and a connecting cable having a bottom end secured to the actuation member of the engagement member and a top end secured to the trigger member wherein the pressing of the trigger member causes the connecting cable to move up which in turn causes the engagement member to activate.

7. A positioning mechanism comprising:
a first member having a plurality of notches vertically disposed along the length;
a second member slidable within the first member having a hole;
an engagement member provided in the second member having a latched member, an actuation member, and a flexible member;
a trigger member on the outside of the second member; and
a connecting cable having a bottom end secured to the actuation member of the engagement member and a top end secured to the trigger member;
wherein the latched member of the engagement member is passed through the hole of the second member to engage with one of the notches of the first member in a locked position, and when the pressing of the trigger member causes the connecting cable to move up, the actuation member is activated to cause the latched member of the engagement member to clear from the notch of the first member and the hole of the second member, thus unlocking the second member.

8. The positioning mechanism of claim 7, wherein the first member is a base.

9. The positioning mechanism of claim 7, wherein the first member is a support bube.

10. The positioning mechanism of claim 7, wherein the second member is a sliding tube.

11. The positioning mechanism of claim 7, wherein the engagement member further comprises a base member shaped to secure the engagement member to the bottom of the second member, an extension member extended upward from the base member a flexible member formed on the top of the extension member, and a pivot member pivotably secured to the second member by a through pin.

12. An engagement device for a positioning mechanism, the engagement device being provided in a second tube having a hole slidable in a first tube having a plurality of apertures, the engagement device comprising:
a base member shaped to secure the engagement device to the bottom of the second tube;
a flexible member extended from the top of the base member;
a latched member on the top of the flexible member;
a pivot member pivotably secured to the second tube by a through pin; and
an actuation member adjacent the pivot member;
wherein the latched member is passed through the hole of the second member to engage with one of the apertures of the first tube in a locked position, and the actuation member is counterclockwise pivotable about the pivot member when actuated for causing the flexible member to compress which in turn causes the latched member to move inward to clear from the aperture of the first tube and the hole of the second tube, thus unlocking the second tube.
